(19) United States
(12) Patent Application Publication
(10) Pub. No.: US 2025/0067659 A1
(43) Pub. Date: Feb. 27, 2025

(54) TESTING DEVICE FOR AN OPTICAL SAMPLE AND METHOD FOR TESTING AN OPTICAL SAMPLE

(71) Applicant: Trioptics GmbH, Wedel (DE)

(72) Inventor: Aiko RUPRECHT, Wedel (DE)

(73) Assignee: Trioptics GmbH, Wedel (DE)

(21) Appl. No.: 18/811,637

(22) Filed: Aug. 21, 2024

(30) Foreign Application Priority Data
Aug. 21, 2023 (DE) 10 2023 122 301.1

(51) Int. Cl. G01N 21/21; G01N 21/17

(52) U.S. Cl. CPC G01N 21/21; G01N 2021/1734; G01N 2201/0633; G01N 2201/0668; G01N 2201/0683

(57) ABSTRACT

A testing device for testing an optical sample that comprises a radiation source for emitting a plurality of optical beams along an optical axis. In addition, the testing device comprises an optical element designed as a filter element for imprinting a specific polarization-direction onto the plurality of optical beams or filtering light reflected or transmitted by the optical sample. The testing device also comprises a rotation unit designed for rotating the optical sample lying on the optical axis by a rotation angle relatively to the filter element. The testing device also comprises a detection unit for determining a polarization axis of the optical sample from the rotation angle and a reflected light beam, from the plurality of optical beams, reflected by the optical sample or transmitted through the optical sample, as well as a measure for the decentration value of the optical sample.

This nonprovisional application claims priority under 35 U.S.C. § 119 (a) to German Patent Application No. 10 2023 122 301.1, which was filed in Germany on Aug. 21, 2023, and which is herein incorporated by reference.

### BACKGROUND OF THE INVENTION

### Field of the Invention

The approach presented herein creates a testing device for an optical sample and a method for testing an optical sample according to the main claims.

### Description of the Background Art

Some lenses have polarization-influencing properties because they either generate the refractive power through said properties (liquid crystal lenses) or are coated correspondingly (polarization layers, quarter-wave layers, etc.). When installing such lenses, not only their centering but also the alignment of the polarization axis is important. However, a multi-step process is often required to measure the centering on the one hand and the alignment of the polarization axis on the other hand. However, such a multi-step process requires additional effort regarding the design of the testing device to measure the centering on the one hand and the alignment of the polarization axis on the other hand in different measurement-process steps. At the same time, such a testing device requires an increased installation space. A sequential measurement of decentration and polarization with two different measuring heads is therefore required. The measurement technology accordingly requires substantial installation space and the two sequential measurement steps lead to long measurement periods.

### SUMMARY OF THE INVENTION

It is therefore an object of the present invention to provide an improved testing device for an optical sample and an improved method for testing an optical sample.

The approach presented herein creates a testing device for an optical sample for determining a decentration value and polarization properties of the optical sample, wherein the testing device comprises: a radiation source for emitting a plurality of optical beams along an optical axis; an optical element, designed as a filter element in the optical axis, for imprinting or filtering a specific polarization-direction of the plurality of optical beams or of light reflected or transmitted by the optical sample; a rotation unit which is designed to rotate the optical sample, located at least in a proximity of the optical axis, by a rotation angle relative to a measurement system and/or the testing unit; a detection unit which is designed to capture light reflected or transmitted by the optical sample and to generate an at least approximately sharp image of the light source or of the reticle; and an evaluation unit which is designed to determine a characteristic value for the centering of the optical sample from the measured runout circle, as well as also to determine a polarization axis of the optical sample from the rotation angle and the associated variation of signal intensity from a light beam of the plurality of optical beams reflected by the optical sample or transmitted through the optical sample.

Furthermore, the approach presented herein creates a testing device for an optical sample, wherein the testing device comprises: a radiation source for emitting a plurality of optical beams along an optical axis; an optical element for collimating the emitted plurality of optical beams; a polarization-influencing optical element designed to imprint a specific polarization-direction onto the plurality of optical beams; a holder for holding the optical sample; an optical element for recollimating the plurality of optical beams focused by the optical sample; a polarization-filtering optical element designed to filter light transmitted by the optical sample; an optical element for refocusing the light transmitted by the optical sample onto a detection plane; a rotation unit which is designed to rotate the optical sample about a beam axis and/or the optical axis, on which the optical sample is located, relatively to the testing device and/or sub-assemblies thereof; and a detection unit for simultaneously determining a decentration value and a polarization axis of the optical sample, based on the rotation angle and a light beam, from the plurality of optical beams transmitted by the optical sample.

A radiation source can be, for example, a light source or lamp that emits corresponding light beams as a plurality of optical beams along the optical axis. Alternatively, this can also be an illuminated reticle. A filter element can be, for example, an optical element which imprints a corresponding polarization-direction onto an incident light. A rotation unit can be, for example, a mechanical unit which rotates the optical sample relatively to the measuring device, wherein this can be carried out either by an active rotation of the optical sample itself when the filter element is at rest or by a rotation of the measuring device when the optical sample is at rest. For example, the rotation unit can be designed to rotate the measuring device or the optical sample by a certain rotation angle, for example around the optical axis or around an axis of the plurality of optical beams, by means of an electric drive. A detection unit can be, for example, an optical sensor or a projection surface onto which light reflected from the optical sample or light transmitted through the optical sample is projected and then evaluated by a corresponding evaluation unit with regard to the position of the polarization axis of the optical sample.

The position of the polarization axis can be very easily evaluated by rotating the optical sample in relation to the filter element. This can be done, for example, by detecting and evaluating a brightness variation during rotation, taking advantage of the fact that, when the polarization axis of the optical sample or a surface of the optical sample is in the same position, with the set polarization-direction that is imprinted onto the light of the plurality of optical beams by the filter element, the light intensity that can be received by the detection unit will be at its greatest. In this way, a testing device for the optical sample can be created using very simple technical means, which makes it possible to detect the polarization axis of the optical sample and at the same time, with the same measuring setup, it is also possible to carry out a centration measurement, i.e. a measurement of the optical center or of the position of the optical axis of the optical sample. The approach proposed herein therefore offers the advantage of measuring a plurality of parameters of the optical sample simultaneously using the proposed measurement setup, which eliminates the need for an additional measurement setup and thus in the case of the testing device saves installation space.

The detection unit can be designed to determine the polarization axis of the optical sample by using a brightness, a brightness pattern and/or a light intensity pattern of the light beam of the plurality of optical beams is advantageous. Such an example offers the advantage of being able to detect the brightness and/or brightness pattern reference or the intensity pattern very easily from a technical perspective and thus to be able to determine the polarization axis of the optical sample precisely.

The rotation unit can be designed to rotate the optical sample and/or the sensor unit around a beam axis and/or the optical axis. For example, such a beam axis can be an axis of a light beam in the plurality of optical beams. Such an example offers the advantage of a compact design of the testing device.

A filter element can be designed to imprint a circular or linear polarization-direction onto the light and/or the detection unit has an analyzer which is designed to allow circularly or linearly polarized light to pass through. Such an example offers the advantage of easily imprinting or evaluating a very precise polarization-direction onto the light of the plurality of optical beams through the filter element, so that the recognition of the polarization-direction of the optical sample can be implemented in a technically simple manner.

The polarization element and the analyzer can be arranged relatively to one another in such a way that a predefined azimuthal angle is set between the polarization-direction defined by the shaping element and a polarization-direction, defined by the analyzer, of the light passing through the analyzer. By setting the predefined azimuthal angle, a further improvement in the precision of the recognition of the polarization axis of the optical sample can be achieved if this angle is known and the polarization axis of a birefringent optical element can also be determined.

The detection unit can be designed to carry out a centering measurement of the optical sample. Such a centering measurement of the optical sample can, for example, comprise a measurement of the optical axis, of the optical center or of another parameter of the optical sample. Such an example of the approach proposed herein offers the advantage of being able with one measurement setup to determine a plurality of parameters such as the polarization axis of the optical sample and a centering value, so that only a very small installation space is required for the testing device and, on the other hand, a measurement can be carried out without the need for a time-consuming switching of the optical sample into different devices or different measurements on one device.

In addition, the detection unit can be designed to use a diameter and/or a radius of a detected runout circle as a measure for the centering measurement. By detecting such a diameter or radius, the centering measurement can be technically implemented or carried out very easily and quickly.

The detection unit can be designed to carry out a determination of the polarization axis and the centering measurement in parallel and/or simultaneously, wherein a brightness variation is detected in the runout circle image in addition to the radius and/or diameter, works particularly efficiently. Such an example makes it possible to create testing devices that require only a small amount of installation space and are easy to handle during operation.

The radiation source and the detection unit can also be installed in an autocollimator together with the polarizing filter element in the optical axis, wherein a beam splitter is provided in order to couple out a light reflected from the optical sample from a beam path parallel to the light radiated by the radiation source. Such an example offers the advantage of a very compact design of the testing device.

An additional rotation of the polarization element in the measurement system can be performed relatively to the measurement system. This can be done either mechanically or optically. An optical rotation of the polarization element can be realized, for example, via a liquid crystal or LCD element. The polarization axis can be rotated by applying a voltage.

The rotation of the polarization element can take place with 1.25 times the physical rotation. With a physical rotation of 360 degrees, an additional rotation of the polarization element of 90° is obtained. In a subsequent second rotation, the additional rotation of the polarizing element increases to 180°, which optically corresponds to the starting configuration. For this reason, for each point of the doubled runout circle, two intensity values are obtained, which are linked to mutually perpendicular polarization-directions and result in correspondingly different or inverted intensity curves. This means that a high signal intensity is also achieved in the regions of the runout circle in which in other examples only a very low signal intensity is present. Due to this complementary intensity curve, by addition of the images, a “complete” runout circle can be used for measuring the decentering value. Alternatively, this advantageous signal reception can also be achieved by the measurement system and the polarization element being mechanically movable relatively to one another and rotating at different speeds.

A collimator with a polarizer attached in front can be used as a filter element and a telescope with an analyzer can be provided in the beam path between an auxiliary lens and/or a decollimation lens.

Also proposed herein is a method for testing an optical sample, wherein the method is carried out using a testing device and comprises: outputting light of a plurality of optical beams from the radiation source through the filter element onto the optical sample and receiving in the detection unit light of the plurality of optical beams reflected or transmitted by the optical sample; carrying out a relative rotational movement between the optical sample and the measurement device; and determining the polarization axis of the optical sample from the light reflected or transmitted by the optical sample.

The advantages mentioned above can also be realized quickly and efficiently using such an example.

The rotational movement of the centering measurement unit can be carried out at a rotational speed different from the rotational movement of the polarizing element(s).

Also provided is a control device that is designed to carry out, control, or realize the steps of the method presented herein in corresponding setups. The object of the invention can also be achieved quickly and efficiently by this example of the invention in the form of a control device.

The control device can have at least one computing unit for processing signals or data; at least one memory unit for storing signals or data; at least one interface to a sensor or an actuator for reading in sensor signals from the sensor, or for outputting control signals to the actuator; and/or at least one communication interface for reading in or outputting data which are embedded in a communication protocol. The computing unit can, for example, be a signal processor, a microcontroller, or the like, while the memory unit can be a flash memory or a magnetic memory unit. The communication interface can be designed to read or output data wirelessly and/or in a line-bound manner, a communication interface that can read or output line-bound data being able, for example, to read these data electrically or optically from a corresponding data transmission line or output them into a corresponding data transmission line.

In the present instance, a control device can be an electrical device that processes sensor signals and, depending thereon, outputs control and/or data signals. The control device may have an interface which may be designed as hardware and/or software. In a hardware example, the interfaces can, for example, be part of what is known as a system ASIC, which includes a wide variety of the functions of the control device. However, it is also possible for the interfaces to be separate integrated circuits or at least partially formed of discrete components. In a software design, the interfaces may be software modules which, for example, are present on a microcontroller in addition to other software modules.

Also advantageous is a computer program product or computer program with program code which can be stored on a machine-readable carrier or storage medium, such as a semiconductor memory, a hard disk memory, or an optical memory, and is used to carry out, implement, and/or control the steps of the method according to the invention, in particular if the program product or program is executed on a computer or a device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an example of a testing device for testing an optical sample;

FIG. 2 shows a schematic representation of the image of the light reflected onto the sensor from the optical sample corresponding to the arrangement of FIG. 1;

FIG. 3 shows a schematic representation of signal curves of a detected light intensity with and without additional rotation of a polarization element;

FIG. 4 shows a schematic representation of an example of a testing device for testing an optical sample in transmission; and

FIG. 5 shows a flow chart of an example of a method.

### DETAILED DESCRIPTION

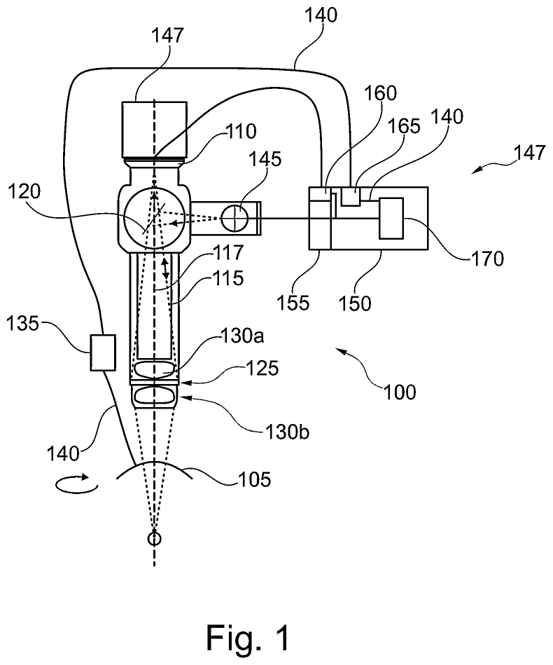

FIG. 1 is a schematic representation of an example of a testing device 100 for testing an optical sample 105. Here, a light beam 115 is deflected from a radiation source 145 along an optical axis 117 in the form of a plurality of optical beams at a beam splitter 120, after which the light beam 115 is incident on a filter element 125. The radiation source can advantageously be combined with a reticle. Here, the filter element 125 can be designed as a polarizer or analyzer and can imprint a certain polarization-direction onto the light of the light beam 115 or can only allow light reflected by the optical sample 105 to pass through in a certain polarization-direction. In addition, for example, a collimation and focusing unit 130 can be provided, which is arranged on the optical axis 117 and can focus the light 115 onto the optical sample 105. The collimation and focusing unit 130 can, for example, be arranged in two sub-units 130a and 130b, each upstream or downstream of the filter element 125 in the beam direction. The optical element 130a is referred to as a collimation lens and the optical element 130b is referred to as a focusing lens or auxiliary lens. In addition, a rotation unit 135 is provided, which is designed, for example, as an electrical drive for rotating the optical sample 105 by a rotation angle 140. In FIG. 1, this rotation is shown in such a way that the rotation unit 135 rotates the optical sample 105 or a holder of the optical sample 105. Alternatively or additionally, the rotation unit 135 can also be designed to rotate the entire measurement system 100 by the rotation angle 140. The rotation unit is controlled via a control unit 165.

The light of the light beam 115 is now reflected by the optical sample 105, more precisely by its surface, wherein a polarizing effect occurs with which especially the light with a high intensity is reflected which is incident in the same polarization-direction that is also most strongly reflected by the surface of the optical sample 105. This reflected light then passes through the beam splitter 120 and is received by a sensor 110 of a detection unit 147. The detection unit 147 can be integrated together with the sensor 110 or can, as a component of the control device 150, be connected thereto via a suitable wired or wireless interface. The sensor 110 can be designed, for example, as a CMOS or CCD camera or a projection screen with a camera directed thereon in order to obtain from the reflected light an image of the center of curvature of a surface of the optical sample 105.

The device 100 can now be operated using a control device 150. Here, the output of light by the radiation source 145 can be controlled by means of an output unit 155. The reflected light or a corresponding signal obtained by the controlled output of the light at the sensor 110 can now be read in via a reading interface 160. If, for example, a rotation of the optical sample 105 by a corresponding rotation angle 140 is controlled, the position of the polarization axis of the optical sample 105 can be determined from the light reflected by the optical sample 105 by means of a determination unit 170 together with the image obtained from the sensor 110.

At the same time, it is also possible to carry out a centering measurement with the setup shown in FIG. 1, which can only be made possible by further evaluation of the image, detected by the sensor 110, of the light reflected from the optical sample 105.

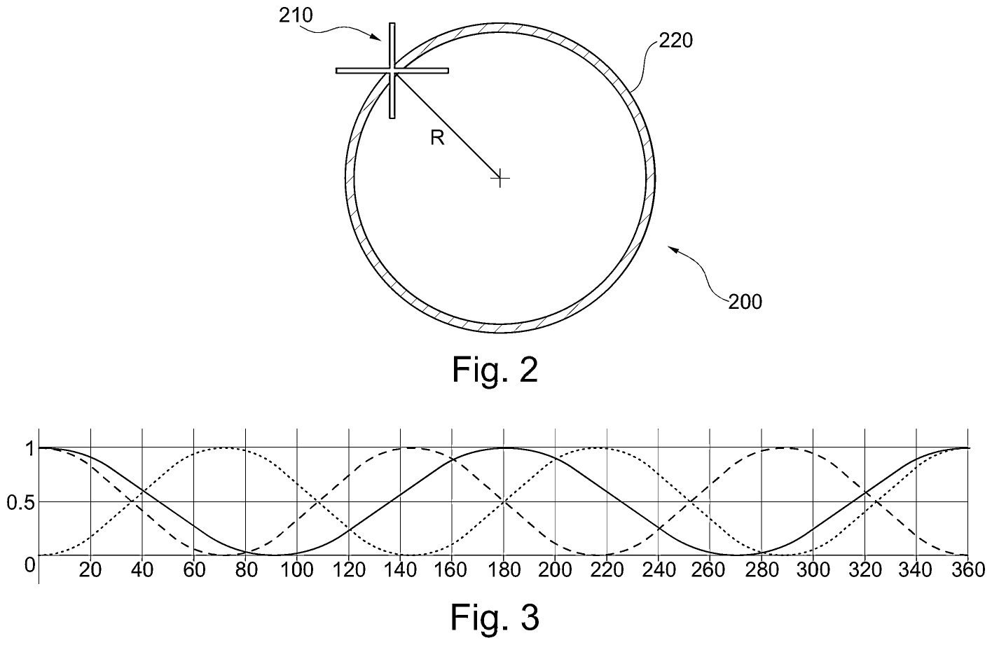

FIG. 2 shows a schematic representation of the image 200 of the light reflected from the optical sample 105 onto the sensor 110. The representation in FIG. 2 shows light reflected or incident on the sensor 110, which forms a corresponding light pattern 210 or intensity pattern. Here, it can be seen that the reflected light creates an image of an object (in the specific example a cross), which forms a runout circle 220 due to the rotation of the optical sample or of the autocollimator. From the radius R of the runout circle, a decentering value of the optical sample 105 can be concluded. Depending on the rotational position of the optical sample and its polarization-influencing properties in relation to the filter element 125, the (light) signal intensity varies within the rotational movement. If all camera images are integrated over a 360° rotation of the filter element 125 or the of optical sample 105, instead of a circle with constant brightness, a sinusoidal intensity distribution that varies with the azimuthal angle will be obtained. In FIG. 2, this variation is indicated by the intensity curve. The rotation angle for which the brightness is at maximum can be the angle at which the polarization axis of the optical sample 105 is oriented. The brightness variation over the rotation angle thus contains the information about the orientation of the polarization axis of the optical sample 105, while the diameter or radius R of the runout circle 220 represents a measure for the centering of the optical sample 105. The rotational movement of the optical sample 105 is therefore used to determine both measured quantities, which are advantageously measured in parallel.

FIG. 3 shows a schematic representation of signal curves of a detected light intensity with and without additional rotation of a polarization element. Here, a normalized intensity is plotted on the ordinate against an angle on the abscissa. The solid sine curve describes the detected signal curve when the optical sample is rotated at a constant rotation speed relatively to the measurement system, without there being any additional rotation of the polarizer/analyzer. In the case of measuring in reflection, this can be achieved by rotating the ACM or rotating the optical sample. The dashed or dotted sine curve arises from a mechanical or optical rotation of the polarizer/analyzer relative to the measurement system at increased speed. This means that a first signal (dashed line) and a second, inverted signal (dotted line) are detected for each azimuthal angle position. By addition of the signal curves, a completely illuminated runout circle is obtained.

A “complete” runout circle can thus be obtained by adding the dashed and dotted intensity curves, as shown in the lower part of FIG. 3.

The centering measurement can thus be conveniently combined with a polarization measurement in one measuring process. This not only keeps the installation space compact, but also minimizes the measuring time. To achieve this, according to an example, the centering measurement, with which a rotation of the optical sample is performed, is linked to a polarizing beam path. The approach presented herein thus makes possible an advantageous combination of centering measurement and polarization measurement, which makes possible a compact measurement setup and a short measurement time.

Depending on the properties of the optical sample, the filter element 125 or the polarizer and/or the analyzer can be designed for circularly polarized light instead of linearly polarized light, or an azimuthal angle can be set between the polarizer and (a separate) analyzer.

Further examples of the testing device presented herein would be, for example:

Collimator with attached polarizer and telescope with analyzer in the beam path between the auxiliary lens and the “decollimation lens.” The centering is measured in transmission.

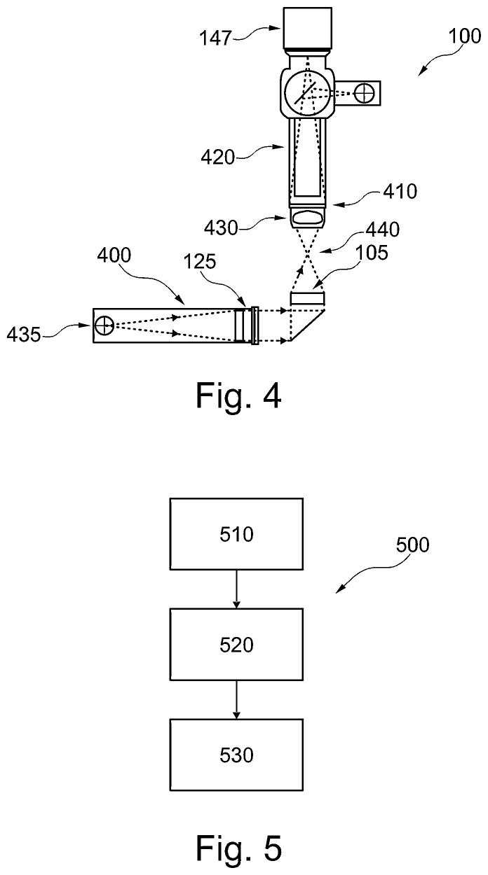

FIG. 4 shows a schematic representation of an example of a testing device 100 for testing an optical sample 105 in transmission, with which the simultaneous measurement of a decentering value and of a polarization-changing property of an optical element is measured in transmission. Here, the decentering value is also determined on the basis of the radius or diameter of a runout circle, which is created by rotation of the optical sample relatively to the measurement system. To determine the polarization-changing properties of the optical sample 105, a polarizing element, for example a polarizer 125, is provided in the collimator 400 and a polarization-filtering element, for example an analyzer 410, is provided in the telescope 420, which has an auxiliary lens 430 and a focusing lens or a “decollimation lens”. The polarizer 125 in the collimator 400 is illuminated, for example, by an illuminated reticle 435. The polarizing elements can for their part be rotated, optically or mechanically, relatively to the measurement system in order to obtain a complementary signal curve, for example as shown in FIG. 3 and described above. The polarizer 125 and analyzer 410 can be rotated independently of one another, or an additional quarter-wave plate can be rotated instead, which is advantageous, for example, when determining the Müller matrix of the optical sample. In addition, the polarizer 125 and the analyzer 410 can have different optical properties. For example, the polarizer 125 can, for example, be designed as a retardation plate or combined or connected with such a plate, so that the light beams behind the collimator 400 have a circular polarization. The light beams are further focused in front of the auxiliary lens 430 or the analyzer 410 at a optical sample focus point 440. Such a variant is for example advantageous when the optical sample 105 changes the polarization of the light beams, for example from circular to linear, which is the case with pancake lenses for AR/VR applications. For such optical samples 105, carrying out the measurement in transmission is therefore particularly advantageous.

FIG. 5 shows a flow chart of an example of a method 500 for testing an optical sample, wherein the method 500 is carried out using a testing device according to a variant presented herein and which comprises a step 510 of outputting light of a plurality of optical beams from the radiation source through the filter element onto the optical sample and receiving in the detection unit a light of the plurality of optical beams reflected or transmitted by the optical sample. Furthermore, the method 500 comprises a step 520 of rotating the optical sample relatively to the filter element and a step 530 of determining the polarization axis of the optical sample from the light reflected or transmitted by the optical sample.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A testing device for testing an optical sample, the testing device comprising:
a radiation source for emitting at least two optical beams along an optical axis;
a polarization-influencing or polarization-filtering optical element located on the optical axis and designed to imprint a polarization-direction onto the at least two optical beams and for filtering light reflected by the optical sample;
a rotation unit designed for rotating the optical sample about a beam axis and/or the optical axis, on which the optical sample is located, relatively to the testing device and/or sub-assemblies thereof; and
a detection unit for substantially simultaneously determining a decentration value and a polarization axis of the optical sample, based on the rotation angle and a reflected light beam, from the at least two optical beams, reflected by the optical sample.

2. A testing device for an optical sample, the testing device comprising:
a radiation source for emitting at least two optical beams along an optical axis;
an optical element for collimating the emitted at least two optical beams;
a polarization-influencing optical element designed to imprint a specific polarization-direction onto the at least two optical beams;
a holder for holding the optical sample;
an optical element for recollimating the at least two optical beams focused by the optical sample;
a polarization-filtering optical element designed to filter light transmitted by the optical sample;
an optical element for refocusing the light transmitted by the optical sample onto a detection plane;
a rotation unit which is designed to rotate the optical sample about a beam axis and/or the optical axis, on which the optical sample is located, relatively to the testing device and/or to sub-assemblies thereof; and
a detection unit for substantially simultaneously determining a decentration value and a polarization axis of the optical sample, based on the rotation angle and an optical beam, from the at least two optical beams transmitted by the optical sample.

3. The testing device according to claim 1, wherein the polarization-influencing elements in the beam path are mechanically and/or optically rotatable.

4. The testing device according to claim 1, wherein the detection unit is designed to determine the polarization axis of the optical sample by using a brightness, a brightness pattern and/or a light intensity pattern of the reflected or transmitted light beam of the at least two optical beams.

5. The testing device according to claim 1, wherein the polarizer is designed to imprint a circular or linear polarization-direction onto the light and wherein the detection unit comprises an analyzer which is designed to allow circularly or linearly polarized light to pass through.

6. The testing device according to claim 5, wherein the polarizer and the analyzer are arranged relatively to one another such that a predefined azimuthal angle is set between the polarization-direction defined by the polarizer and a polarization-direction, defined by the analyzer, of the light passing through the analyzer.

7. The testing device according to claim 1, wherein the detection unit is designed to determine the decentration value from a detected runout circle of a brightness variation.

8. The testing device according to claim 1, wherein the radiation source and a sensor are installed in an autocollimator together with the polarizer and/or an analyzer in the optical axis, and wherein a beam splitter is provided in order to couple out a light reflected by the optical sample from a beam path substantially parallel to the light radiated by the radiation source.

9. A method for testing an optical sample, the method being carried out with the testing device according to claim 1, the method comprising:
emitting light of at least two optical beams from the radiation source onto the optical sample, wherein at first a polarization is imprinted onto the at least two optical beams,
receiving a light of the at least two optical beams reflected by the optical sample or transmitted through the optical sample in the detection unit;
rotating the optical sample relatively to the testing device and/or sub-assemblies of the testing device; and
determining, substantially simultaneously, the polarization axis of the optical sample and its decentration value from the light reflected or transmitted by the optical sample.

10. The method according to claim 9, wherein the polarization-influencing elements are rotated relatively to the testing device and in that for each azimuthal angular position of the optical sample in the course of at least two revolutions a first intensity signal and a second intensity signal deviating therefrom are detected.

11. The method according to claim 10, wherein, for measuring the decentration value, the first intensity signal and the second intensity signal are added to obtain a runout circle with an intensity variation within a tolerance range.

12. A control device configured to execute and/or control the steps of the method according to claim 9 in corresponding units.

13. A computer program configured to execute and/or control the steps of the method according to claim 11.

14. A machine-readable storage medium on which the computer program according to claim 13 is stored.
